(19) United States
(12) Patent Application Publication
(10) Pub. No.: US 2009/0276485 A1
(43) Pub. Date: Nov. 5, 2009

(54) Method of playing back digital content, and an appliance and a server for implementing such a method

(76) Inventor: Alexander Casassovici, Neuilly-Sur-Seine (FR)

Correspondence Address: O'BRIEN JONES, PLLC, 8200 Greensboro Drive, Suite 1020A, McLean, VA, 22102, US

(21) Appl. No.: 11/970,714

(22) Filed: Jan. 8, 2008

(30) Foreign Application Priority Data
Jan. 8, 2007 (FR) 07 52571

(51) Int. Cl. G06F 15/16

(52) U.S. Cl. 709/203; 345/76

(57) ABSTRACT

The present invention provides a method of playing back at least one digital content by means of at least one appliance for playing back said content, the method comprising the following steps:
enabling at least one user account to be created on a server of a computer network providing access to at least one content supplier site, the account being created in particular by means of a terminal other than the playback appliance;
enabling at least one user profile to be defined on the user account; and
depending on the user profile, sending at least one address of digital content present on a content supplier site from the server to the playback appliance connected to the network, thereby enabling the playback appliance to recover and play back said digital content via playback means.

The present invention relates to a method of playing back digital content by means of a content playback appliance, in particular a digital picture frame.

### BACKGROUND

At present digital picture frames are to be found on the market that include an incorporated memory card reader. Those digital picture frames present the drawback of requiring the memory card to be changed in order to modify the content that can be displayed.

U.S. Pat. Nos. 6,961,046 and 6,717,567 disclose digital pictures frames arranged to receive images sent over a wireless connection by an associated source such as a digital camera or a personal computer. Each time it is desired to modify the displayable content, it is necessary to act on the external source.

US patent application US 2002/0126150 discloses a digital picture frame capable of exchanging data with a digital camera via a local wireless network. That application also discloses, but without giving details, a digital picture frame that incorporates a modem for connecting to a telephone outlet in order to enable the digital picture frame to dial an Internet access number and receive images for display.

The supplier eStarling sells a digital picture frame capable of connecting to the Internet over a WiFi connection and of displaying images received from a messaging server at an email address.

On its side, the frame includes the following keys: forward, reverse, slide show, rotate, delete, and web update.

Putting the picture frame into operation requires it to be connected to a personal computer via a USB cable, which means that the user must have such a computer available on the same site as the picture frame.

The picture frame can play back content that reaches the messaging address, but is capable of loading the content only with difficulty.

However, such a function can be desirable when the picture frame is placed in a room where several people live, each having a preference for a source of content and/or a type of content that is not necessarily the same as the others.

There exists a need to further improve appliances for playing back digital content, such as digital picture frames, for example.

The invention seeks to satisfy that need by enabling a user to benefit from a content playback appliance that is simultaneously reliable in operation and easy to use, in particular when the user desires to modify the displayed content, and that makes it possible to augment considerably the types of content that are supported.

### SUMMARY

In a first of its aspects amongst others, the invention provides a method of playing back at least one digital content by means of at least one appliance for playing back said content, in particular a digital picture frame, the method comprising the following steps:
enabling at least one user account to be created on a server of a computer network providing access to at least one content supplier site, the account being created in particular by means of a terminal other than the playback appliance;
enabling at least one user profile to be defined on the user account; and
depending on the user profile, sending at least one address of digital content present on a content supplier site from the server to the playback appliance connected to the network, thereby enabling the playback appliance to recover and play back said digital content via playback means, in particular sound and/or visual playback means.

The invention makes it easy to personalize and renew the digital content played back since this may be done with the help of the server that manages the user account.

In addition, the content may be received in accordance with the invention from content supplier sites that are distinct from the server, thereby enabling content sources to be diversified.

Furthermore, in accordance with an aspect of the invention, by using a terminal other than the playback appliance in order to access the user account and to create, modify, copy, or consult at least one user profile, it may be easy for the playback appliance to be put into operation without it requiring a user interface that is complex, thus making the appliance simpler to manufacture.

Furthermore, the displayed content may be modified easily. For example, the server may be arranged so as to enable the user having a user account to create a new profile copied from a third-party profile, thus saving time and enabling the user to benefit from a profile that enables content about a given subject to be obtained efficiently.

Where appropriate, the playback appliance may be put into operation without any physical connection between the playback appliance and the terminal.

The search for a supplier of content for playing back may not be performed by the playback appliance, but may be performed by the server, as a function of the user profile(s).

The server may be arranged, as a function of a user profile, to make at least one request with a supplier site in order to obtain at least one address enabling the playback appliance to access at least one content corresponding to said user profile. The request may be made on the basis of information associated with the user profile, e.g. keywords. The server may thus act as a kind of search engine in order to provide the user with content that matches the user profile under consideration.

In an implementation of the invention, the method includes a step of sending at least one notification to the playback appliance connected to the network, informing it that at least one new digital content for playing back has been made available.

In order to receive such a notification, the playback appliance may periodically interrogate the server about the existence of new digital content for playing back. This interrogation may be necessary in order to enable the playback appliance to receive the notification in the presence of a firewall.

The reception of such notification may be signaled on the playback appliance by a sound and/or visual message, e.g. by a change in the state of an indicator light and/or by displaying a pictogram.

Signaling that a notification has been received may enable the user to act on the playback appliance in order to cause the new digital content to be received or to be deleted.

Where appropriate, the notification may include at least information relating to the type and/or the origin of the new content, it being possible for said information to be displayed by the playback appliance, for example.

The term “type of content” is used to mean content of image, video, audio, or other type. Information relating to content type, e.g. sent by the server to the playback appliance, may include identification of the site from which the content comes.

The method may include supplying the playback appliance together with a network address of the server and an identifier of the playback appliance. By way of example, the identifier may be its MAC address, where a MAC address is a physical identifier stored in a network card or in a network interface and enabling an address to be allocated that is unique on a worldwide scale.

The server may be arranged to send at least one Link to the playback appliance pointing to a digital content on the content supplier site. The playback appliance may be arranged to download the content automatically, e.g. in push mode.

A user account may include a plurality of user profiles and the user may have the option to select one of them by default, e.g. the profile that was selected when the playback appliance was put into operation.

The server may send to the playback appliance the list of user profiles that exists on the account, and the user may act on the playback appliance in order to select one of the user profiles from amongst the profiles in the list so as to play back content that corresponds to the selected profile. This may enable the played-back content to be changed simply and quickly, e.g. when there is a change of person in the surroundings of the playback appliance.

By way of example, the list of available user profiles may be displayed by the playback appliance, at least while a profile is being selected.

The digital content may include at least one image or video file, for example selected from files having any of the following formats: *.arr, *.mpg, *.mov, *.esf, *.wmv, *.dvx, *.qt, *.avi, *.jpg, *.bmp, *.png, *.tif, *.ps, and *.eps.

The digital content may include at least one audio file, e.g. selected from files of the following formats: *.wav, *.mp3, *.ra, *.ram, *.aiff, *.en, *.mid, *.ogg, *.asf, and *.aac.

The server may send reader software to the playback appliance, where such software is also known for short as a “reader” or a “player”, for use in reading the digital content as a function of the type of digital content that is to be played back. By way of example, the software may be for reading images, videos, or sound files, and may enable the digital content to be played back on the playback appliance, given its specific technical features.

Creating a user account may comprise giving the server an identifier for the user and for the playback appliance. A user account may relate to a plurality of playback appliances.

The server may be arranged to enable the user to add a playback appliance to an existing account and to define for that playback appliance the user profile(s) that are to apply thereto.

Consultation of a user profile may optionally be freely accessible.

The server may also be arranged to enable the user to share a user profile amongst a plurality of playback appliances.

For example the server may be arranged to enable a user to make a user profile public so that other users connecting to the server may duplicate that profile and associate it with a given playback appliance.

The server may also be arranged in such a manner as to enable a user profile to be shared only amongst third parties previously identified by the user, e.g. third parties who are also clients of the server. The server may be arranged to list the addresses of such third parties.

Creating a user account may include inputting an identifier or password enabling access to the user account to be made selectively.

Creating a user profile may include selecting one or more time periods associated with the playback appliance receiving one or more contents. Each profile may be associated, for example, with a time period during which the playback appliance receives a corresponding content.

The method of the invention may include a step consisting, while content is being played back, in enabling the user to act on a user interface of the playback appliance, and may also include a step consisting in modifying the received content as a function of said action. For example, by acting on the playback appliance, the user may cause it to send the server at least one instruction leading to the server changing the current user profile so as to send new content to the playback appliance corresponding to a new user profile as selected by the user on the playback appliance.

The server may send a list of addresses to the playback appliance, and the playback appliance may connect thereto in succession in order to download the corresponding contents.

For example, when the playback appliance is arranged to display a slide show, the server may send a list of addresses to the playback appliance corresponding to the different images of the slide show.

The playback appliance may be arranged to enable the user to scroll through the images, e.g. in response to action on a key.

The method of the invention may include a step consisting in using a hardware interface of the playback appliance to exchange data with at least one peripheral selected from a printer, a microcomputer, a scanner, a digital camera, a digital personal assistant, a telephone, a camera phone, a home alarm, a video surveillance system, an video and/or audio port of a multimedia appliance, a motion picture camera, a home network interface, a weather station, a USB memory stick, or any other electronic appliance for creating, storing, or playing back digital information and having wireless or other communications means. For example, this may make it possible to take advantage of a screen of the playback appliance for displaying additional information corning from the peripheral, either temporarily or continuously, e.g. in the absence of displayed digital content, or in alternation therewith.

The playback appliance may not be provided with: a complete alphanumeric keyboard, a hard disk, a floppy disk reader, or an optical disk reader, thereby making it simpler to manufacture.

The playback appliance may include sound and/or visual playback means.

The playback appliance may include a screen, in particular an integrated screen, forming a one-piece unit with the remainder of the playback appliance.

In a variant, the playback appliance may not itself include sound and/or visual playback means and it may be designed to be connected to external sound and/or visual playback means.

For example, the playback appliance may be designed for connection to a monitor or to a stereo system over wireless or other connection, or else it may be connected to a video input of a TV set or of a video projector.

Where appropriate, the playback appliance may have a video and/or audio input enabling it to be used as a monitor or as a loudspeaker, e.g. when not receiving data from the network.

The playback appliance may include wireless communications means, e.g. an interface of the WiFi type, for exchanging data with the computer network, which network may be the Internet. These communications means may optionally be removable and may optionally be integrated with the remainder of the playback appliance while it is in use.

Where appropriate, the terminal may access the content present on the supplier site and download it by the playback appliance.

In another of its aspects, independently or in combination with the above, the invention also provides a method of playing back digital content by means of a content playback appliance, in particular a digital picture frame, the method comprising the following steps:
enabling at least one user profile associated with a user account to be defined on a server of a computer network giving access to at least one content supplier site;
as a function of the user profile, sending from the server to the playback appliance connected to the network, at least one address of digital content present on a content supplier site in order to enable the playback appliance to recover the digital content and play it back via sound and/or visual playback means;
enabling the server to send to the playback appliance a list of user profiles associated with a user account;
enabling the user to select a user profile by acting on a user network of the playback appliance; and
as a function of the new user profile as selected in this way, sending to the playback appliance at least one address of corresponding digital content.

Where appropriate, in such a method, the server may send information to the playback appliance specifying the type of reader or reader software needed for reading the digital content at the address sent, e.g. a video, image, or sound reader, and the playback appliance may be arranged to download the reader before downloading the digital content.

The method of the invention may include displaying on the screen at least one function associated with a key of the playback appliance, with the displayed function itself being a function of the displayed content, for example, in particular of the content type, e.g. video, image, or sound, and/or the site from which it comes.

The method may include detecting that the user is in the proximity of the appliance in order to cause the function to be displayed on the screen, thus making it possible to avoid permanently decreasing the display area that can be used for playing back content.

In another of its aspects, independently or in combination with the above, the invention also provides a method of playing back digital content by means of a content playback appliance, in particular a digital picture frame, the method comprising the following steps:
periodically using the playback appliance to interrogate a server arranged to notify the availability of new digital content;
using the server to interrogate at least one supplier site in order to detect the presence on said supplier site of new digital content, and in the affirmative, to notify the presence of said new digital content to the playback appliance;
using the server to send a notification to the playback appliance relating to the presence of new digital content, said notification comprising at least the address enabling the new content to be recovered from the supplier site and optionally the address of a reader software that corresponds to said new content; and
in response to an action of the user on a user interface, enabling the playback appliance to recover the digital content at the address as communicated in this way by the server.

All the sites associated with at least one user profile that is defined for automatically downloading new content (push mode) may thus be interrogated by the server.

In another of its aspects, the invention also provides a computer system comprising:
an appliance for playing back digital content, the appliance not being provided with a complete alphanumeric keyboard, and possibly including sound and/or visual playback means, and being capable of accessing a network; and
a server accessible via the network, the server being arranged:
to enable a terminal to be connected to the server, in particular a terminal that is distinct from the playback appliance;
to enable a user account defining at least one user profile associated with the playback appliance to be created;
to search, as a function of the user profile, for at least one address on a content supplier site accessible via the network; and
to cause the playback appliance to download content from the content supplier site from the address as searched-for in this way, in particular by sending said address to the playback appliance.

The computer system may include one or more of the characteristics mentioned above with respect to the playback method.

In another of its aspects, the invention also provides a digital content playback appliance, in particular an appliance not having a complete alphanumeric keyboard, and possibly including sound and/or visual playback means, the appliance including a digital processor unit arranged to enable it:
to connect automatically to a computer network server other than a messaging server;
to identify itself with the server;
to recover automatically from the server at least one address pointing to at least one content supplier site distinct from the server, said address(es) being a function of a user profile defined by the server; and
to connect automatically to the addresses received from the server to recover the content for playback.

The playback appliance may be arranged to notify the availability of at least one new digital content for playback, on receiving at least one corresponding notification from the server.

In particular, the playback appliance may be arranged to issue a visual and/or sound signal signaling the reception of a notification, initially without giving more information other than merely indicating that the notification has been received, and then, after the user has taken some action, e.g. on a user interface of the appliance, to display at least some information about the type of new content, possibly the profile with which it is associated, particularly in the event of said profile being different from the current profile associated with the content that was being played back when the notification was received.

The appliance may be arranged to make a wireless connection to the network. In certain implementations of the invention, the appliance may include at least one screen and/or at least one loudspeaker.

The appliance may include at least one trim element fitted with releasable fastener means, in particular using magnetic fastening, thus enabling the appearance of the appliance to be personalized.

The appliance may include a tinted or semi-reflecting glass or film covering the screen, at least in part, and possibly extending over substantially the entire front face thereof, thus serving to mask the keys of the appliance, where appropriate, and in particular when they are touch-sensitive keys.

The appliance may include a hardware interface enabling data to be exchanged locally with at least one peripheral selected from: a printer, a microcomputer, a scanner, a digital camera, a digital personal assistant, a telephone, a camera phone, a video surveillance system, a home alarm, a video and/or audio port, a motion picture camera, a home network interface, a weather station, a USB memory stick, or any other electronic appliance for creating, storing, or playing back digital information and including wireless or other communications means.

The appliance may include a user interface having means for displaying on the screen at least one function associated with a key of the playback appliance, where appropriate as a function of the content being played back, in particular as a function of the type of content, e.g. video, image, or sound. The appliance may be arranged to make the displaying of key functions conditional on detecting that the user is in the proximity of the appliance.

The appliance may be in the form of a digital picture frame.

The appliance may include a prop, e.g. having two branches so as to enable the screen to be placed either in a landscape position or in a portrait position. The orientation of the screen may optionally be detected automatically so that images are displayed with the proper orientation.

The prop may be fastened removably to a rear face of the appliance so as to make it easier to fasten the appliance on a wall, where appropriate, or to fasten the appliance to at least one trim element that makes it possible to do without the prop.

The prop may be fastened to the rear face by magnetic means, for example.

The appliance may include a removable cover suitable for being fastened on the rear face instead of the prop in order to hide the magnet(s) used for fastening the prop. The cover may itself be magnetic, where appropriate.

A plurality of trim elements of different appearances may be made available to the user.

The playback appliance may be arranged in such a manner that at least one trim element may be secured to a front or rear facade of the appliance by means of at least one magnet contained in the appliance.

In another of its aspects, the invention also provides a server enabling a connection to be made via a computer network with at least one playback appliance as defined above, the server being arranged to enable a user account to be created and at least one user profile to be defined, and as a function of said profile to search at least one digital content supplier site for at least one address of content corresponding to the profile, and to send said address to the playback appliance in order to enable it to download the corresponding content from the address.

The server may be arranged to send the list of user profiles associated with a user account to the playback appliance, and to receive information from the playback appliance relating to a selected profile.

The server may be arranged to search content supplier sites as a function of a user profile for the existence of new content, and to send a corresponding notification to the playback appliance.

The server may be arranged to send said notification to the playback appliance in response to an interrogation from the playback appliance. The notification may include as information at least the type of the new content, the address(es) of the new content, and possibly the reader needed for reading the new content.

The server may be arranged to send to the playback appliance, a reader that corresponds to the type of content for downloading from a content supplier site.

The server may also present other characteristics such as those defined above, in particular with reference to the playback method.

In another of its aspects, and independently or in combination with the above, the invention also provides a digital picture frame comprising:
a screen;
preferably, also a loudspeaker;
a digital processor unit;
an interface for wireless data transmission/reception with a computer network; and
a user interface including keys,

the appliance being arranged to display on the screen functions associated with the keys.

Such a display makes it possible to increase the capabilities of the user interface without correspondingly increasing the number of keys, and thus making the frame more complex to manufacture.

Advantageously, functions are displayed in response to an action of the user or in response to detecting that the user is in the proximity of the appliance.

Also advantageously, the frame includes at least one removable trim element so as to make it easy to modify the appearance of the frame.

The functions displayed may depend on the type of content being played back.

### BRIEF DESCRIPTION OF THE DRAWINGS

The invention can be better understood on reading the following detailed description of non-limiting implementations thereof and on examining the accompanying drawings, in which:

FIG. 1 is a diagrammatic and fragmentary view showing an example of computer architecture for implementing the method of the invention;

FIGS. 2 to 8 show various steps in the implementation of an example of the method of the invention;

FIGS. 9 to 14 are diagrams showing screen pages that can be displayed on the terminal during connection to the server;

FIG. 15 is an exploded diagrammatic perspective view of an example of a playback appliance;

FIG. 16 shows the playback appliance in two orientations;

FIG. 17 shows the playback appliance without its prop;

FIG. 18 shows the playback appliance from the side;

FIGS. 19 and 20 show how at least one trim element can be fastened on the playback appliance;

FIG. 21 is a front view of the playback appliance;

FIG. 22 is a diagrammatic view shown in another embodiment of the playback appliance; and

FIGS. 23 to 27 show examples of how functions can be displayed on the screen.

### MORE DETAILED DESCRIPTION

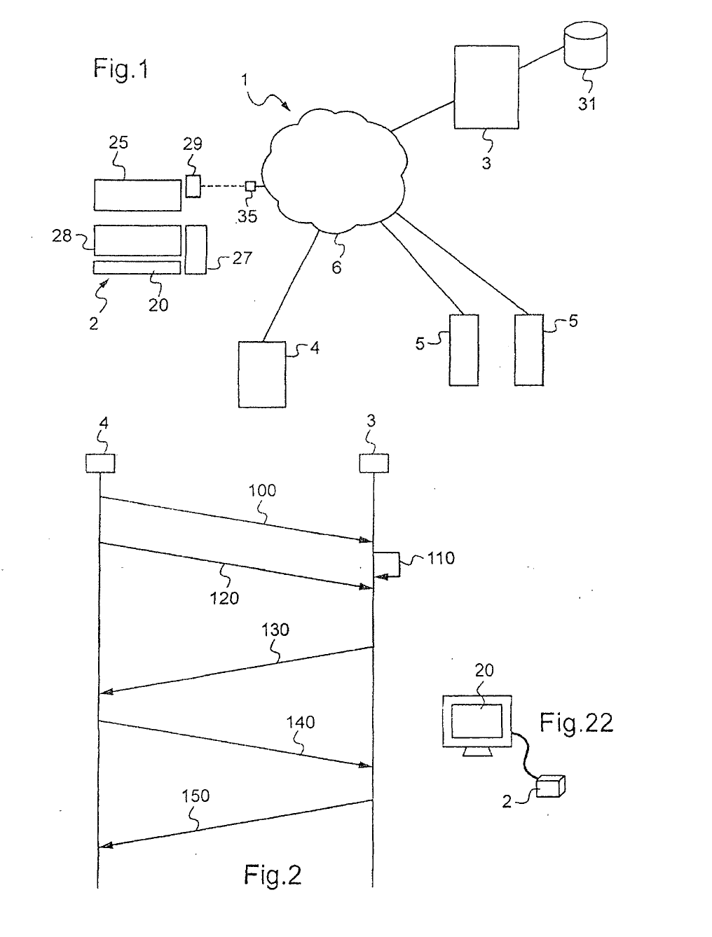

With reference to FIG. 1, it can be seen that the digital content playback appliance 2 of the invention can be implemented within an architecture 1 involving a computer network 6, e.g. including the Internet, at least one server 3, at least one terminal 4, and at least one content supplier site 5.

The playback appliance 2 may include means 20 for playing back digital content, such as, for example, a projector, a screen, and/or at least one loudspeaker.

The screen may be of any type, e.g. a liquid crystal display (LCD), a back projection screen, a plasma screen, a light-emitting diode (LED) screen, in particular an organic light-emitting diode (OLED) screen, or any other kind of screen, and it is preferably a color screen.

By way of example, the resolution of the screen may be greater than or equal to quarter video graphics array (QVGA) resolution, e.g. VGA resolution.

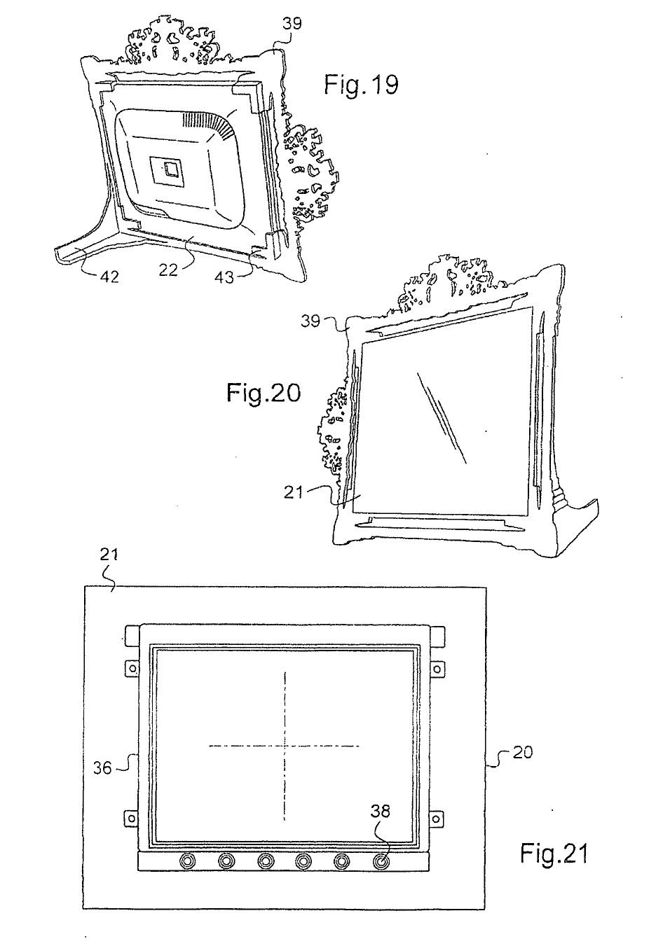

The playback appliance 2 need not necessarily include its own digital content playback means, but it could be designed for connection to external digital content playback means such as, for example: a monitor, a TV set, a stereo system, a personal music player, a video projector, amongst others. Under such circumstances, the content playback means may be connected by wire or otherwise to the playback appliance 2, as shown in FIG. 22.

The playback appliance 2 may be supplied to the user without a digital content reader of predefined type, e.g. without a reader for reading images in .jpg, .gif, .bmp, or .pdf, or other format.

The playback appliance 2 may be arranged to load a reader that is adapted to the type of content that is to be played back.

The playback appliance 2 includes a digital processor unit 28 having at least one processor, e.g. at least one microprocessor or microcontroller, at least one data storage element such as a static and/or volatile memory circuit, for example, and an integrated operating system.

The playback appliance 2 further includes an interface 29 for sending/receiving data enabling it to be connected to the network 6. This interface 29 may form a permanent part of the playback appliance or it may be removable.

In an implementation of the invention, the playback appliance 2 is arranged to exchange data over a wireless connection with the network 6, and by way of example the send/receive interface 29 comprises a wireless communication module, e.g. of the wireless personal area network (WPAN) type, e.g. Bluetooth or ZigBee or infrared, of the wireless local area network (WLAN) type, e.g. WiFi, or of the wireless wide area network (WWAN) type, e.g. the global system for mobile communication (GMS), the general packet radio service (GPRS), or the universal mobile telecommunications system (UMTS).

The playback appliance 2 may be connected to the network 6 using an ad hoc or an infrastructure mode of operation, for example.

The playback appliance 2 may be connected to the network via an asymmetric digital subscriber line (ADSL) or other router 35, the invention not being limited to any particular means enabling the playback appliance 2 to be connected to the network 6, and the connection between the playback appliance 2 and the network 6 may be wired or wireless.

The playback appliance 2 further includes a user interface 25 that can be controlled by the processor unit 28 and that can optionally include an additional hardware interface 27 in addition to the interface 29 enabling data to be exchanged with the network 6.

By way of example, the additional hardware interface 27 includes at least one connector enabling it to receive a memory card, e.g. for the purpose of enabling the playback appliance to operate in a self-contained manner by reading data present on the memory card.

The additional hardware interface 27 may also include a connector enabling data to be exchanged over a wire connection with a computer or a peripheral, e.g. a universal serial bus (USB) connector, a serial connector, or a parallel connector.

The playback appliance 2 may also include an electrical power supply connector.

The additional hardware interface 27 and/or the interface 29 for sending/receiving data may be arranged, where appropriate, to be capable of communicating with at least one peripheral that is not shown and that is selected from: a printer, a microcomputer, a scanner, a digital camera, a digital personal assistant, a telephone, a camera phone, a home alarm, a video surveillance system, a video and/or audio port of a multimedia appliance, a motion picture camera, a home network interface, a weather station, a USB memory stick or flash drive, or indeed any other electronic appliance for creating, storing, or playing back digital information and having wired or wireless communications means.

The operating system integrated in the playback appliance 2 may perform at least part of: downloading content, managing the display, and/or the playback of sound, and also managing the hardware, user, and network communication interfaces 27, 25, and 29.

Management of the user, hardware, and communication interfaces 25, 27, and 29 may also be performed at least in part by specialized components.

By way of example, the interface 27 may thus include a two mode (master and slave) USB controller. When the playback appliance 2 includes a screen 20 or is designed for connection to an external screen, the playback appliance 2 may include, for example, an integrated video decoder of the digital signal processor (DSP) type.

By way of example, the operating system of the playback appliance 2 can be based on Linux®, but the invention is not limited to any particular software.

The user interface 25 may include a limited number of keys, e.g. fewer than ten, better fewer than seven, to avoid excessively complicating manufacture of the appliance.

When the playback appliance 2 includes a screen 20, the user interface 25 may cause the screen 20 to display at least one function associated with a key of the appliance, which function may be associated permanently or temporarily, e.g. depending on the content being played back by the appliance 2.

The keys may be of any type, e.g. they may be touch-sensitive or pushbutton.

The function of a key may be displayed on the screen either permanently or in response to an action by the user or on detecting that the user is in the proximity of the appliance, e.g. by means of an infrared sensor or a field-effect sensor.

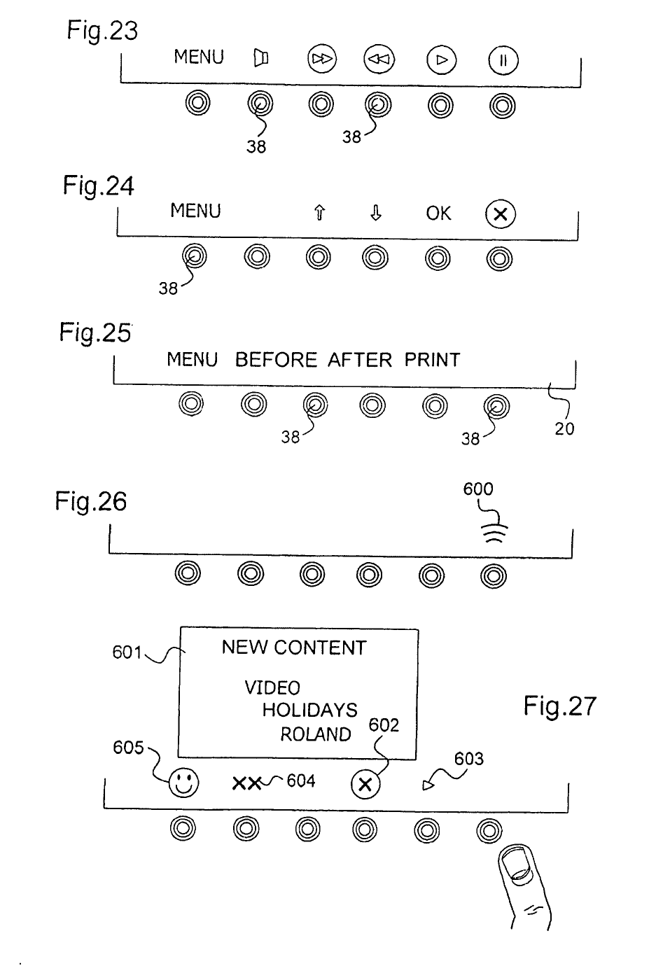

By way of example, FIGS. 23 to 25 show examples of functions that may be displayed on the screen 20, e.g. above keys 38.

When the played-back content is a video, the functions that may be displayed on the screen may be, for example: read, fast forward or back, adjust sound, or pause, as shown in FIG. 23.

When an image is displayed on the screen, e.g. while viewing a slide show, the functions that can be displayed on the screen may for example be functions that make it possible to move from one image to another or to print an image, as described below.

A menu function may also be displayed together with functions for navigating within the menu and for selecting or deleting, as shown in FIG. 24.

By way of example, the functions associated with the keys 38 of the user interface 25 may also be the following:
“change profile” for modifying the profile selected from profiles predefined in the user account;
“sleep” for switching off the playback appliance after a predefined duration;
“change access” for connecting the playback appliance to the network via another access point;
“sleep start/stop” for enabling the user to program times at which the playback appliance is switched on and put on standby; and
“status” to enable a user to consult the status of the playback appliance, e.g. in order to know which profile is current;
date, and/or time, or alarm settings; and
image, brightness, and/or contrast settings.

A “menu” key can enable the user to configure network access manually, e.g. by inserting a wired equivalent privacy (WEP) key, or a WiFi protected access (WPA) key when using a WiFi connection.

The user interface 25 may also include a receiver of infrared or radio signals coming from a remote control, e.g. a specific remote control provided with the playback appliance or a remote control used by some other appliance, e.g. a TV set or a hi-fi system.

In another implementation of the invention, the user interface 25 includes a microphone and a voice message decoder.

In accordance with the invention, the playback appliance 2 is arranged to receive a content for playing back from at least one content supplier site 5 as a function of information previously sent to the server 3, e.g. by the terminal 4.

In the implementation shown, the server 3 is arranged to access a database 31 storing information relating to at least one user account associated with the playback appliance 2.

The database 31 to which the server 3 has access may for example be programmed by using the PHP language, and the database may be managed by appropriate software, e.g. MySQL.

The user account enables to associate at least one playback appliance 2 with the identifier of a user and also with at least one user profile for determining the type of content that is sent to the playback appliance 2 from one or more content supplier sites concerned.

The server 3 may present an architecture of the external module (plug-in) type, enabling easy access by means of modules providing extensions to services newly available on the network 6.

The server 3 may be arranged to send to the playback appliance 2 at least one piece of content reader software as a function of a corresponding user profile and of the type of content. This may enable the playback appliance to access a great variety of types of content without it being necessary for the processor unit 28 to be complex, and in particular without it being necessary for it to have a large memory, since the reader software that is adapted to one particular type of content may be downloaded by the playback appliance just before playing back the content, and it need not reside permanently in the memory of the playback appliance.

Naturally, that corresponds to only one aspect of the invention, and the invention is not limited to a playback appliance that receives reader software (also known as a “reader” for short) from the server, and in a variant the playback appliance may be made available to the user with at least one resident reader, e.g. an image type content reader, such as a .jpg reader.

At any one moment, the playback appliance need have only one reader that is adapted to one type of content.

The database 31 may optionally associate a user account with identification and/or access data that may be required for connection to a content supplier site. By way of example, such data may comprise a password, an identifier, an email address, a name, or any other information that might be needed to enable the content supplier site to recognize the user and deliver the requested content to the user.

The server 3 may be arranged in such a manner that a user account can be accessed only after the user has been identified, e.g. by means of a password and/or an identifier.

The user profile(s) associated with a user account may be modifiable only by an authorized user, after the user has been identified during access control.

The user may optionally decide on access control associated with one or more user profiles, e.g. by accepting that a given profile should be consultable and/or modifiable by other users.

Where appropriate, access to a user profile may be paid for. This may apply, for example, when the user profile in question enables content of restricted access to be received by the playback appliance, e.g. content that is protected by intellectual property rights and that requires authorization in order to be played back.

A user profile may include all of the information that is of use to enable the server 3 to search for content in compliance with a theme predefined by the user.

A user profile may include identification of the media corresponding to the played-back content, e.g. whether the content is of the image, video, or audio type.

A user profile may also include identification of a content supplier site where the server 3 is to search for content corresponding to a user request. For example, when playing back images, the site may be flickr.com, and when playing back a video file it may be youtube.com.

The invention is not restricted to a particular content supplier site, and the site may for example be a personal computer within a peer-to-peer (P2P) network.

A content supplier site may also be a messaging server.

With an appliance for playing back audio content, the user profile may include identification for web radios, for example.

A user profile may also include one or more contact filters, in particular one or more keywords, also known as tags, that may be selected as a function of the content supplier site. By way of example, on creating a new user profile, the user may specify a desire to receive images relating to scuba diving and may enter “diving” as a keyword, such that the server 3 searches for content using that keyword.

As mentioned above, the user profile may also include the password together with the identifier used by the user for connecting to a content supplier site, e.g. the identifier of an email account belonging to the user.

The user profile may also include information about a protocol for playing back the content, e.g. an order in which received files are to be played back or indeed the frequency at which images should be changed when the played-back content is of the image type, or the way in which a transfer is made from one image to the next.

The server 3 may define at least one default user profile, which the user may modify, when appropriate.

The server 3 is arranged to enable the playback appliance 2 to receive content corresponding to one or more user profiles, and it may optionally offer other functions to the user, e.g. messaging, image or video storage, on-line shopping, amongst others.

In order to define the user account and the associated user profile(s), access to the server 3 is performed, according to one aspect of the invention, by means of a terminal 4 other than the playback appliance 2.

This access may take place without the playback appliance 2 being physically connected to the terminal 4.

The terminal 4 may be of various kinds, for example it may be a personal computer, a mobile telephone, a digital personal assistant, or a telephone handset, with the server 3 being capable of responding to voice commands, where appropriate.

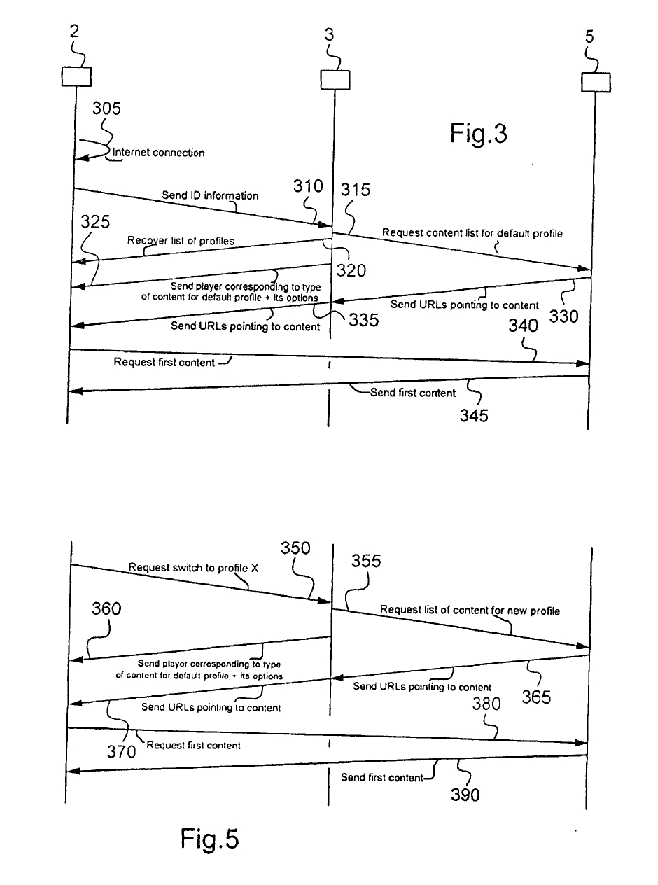

FIG. 2 shows an example of the information exchanged between the server 3 and the terminal 4 while creating a user account.

During an initial step 100, the terminal 4 connects to the server 3 and sends the user identifier. By way of example, such an identifier is the name of the user or a password.

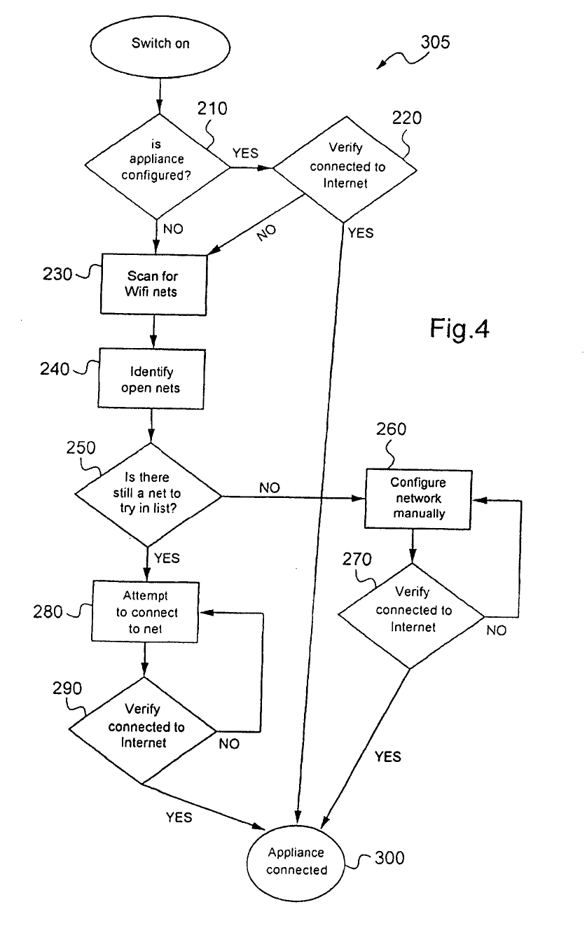

The page that is displayed on the terminal 4, assuming it has a screen, may be as shown in FIG. 9 by way of example.

In this figure, it can be seen that the page has two zones for entering the identifier or the password and may also include: a drop-down list for selecting a language; advertising; and links to other functions, e.g. a link for downloading public profiles when the user already has a user account.

During a step 110, the server 3 determines whether the received identifier is already stored in the database 31, as happens, for example, when the user is seeking to associate a new playback appliance to an existing user account.

In a step 120, the terminal 4 sends a serial number or any other identifier of the playback appliance 2 to the server 3. This identifier may be constituted by the media access control (MAC) address of the playback appliance 2.

FIG. 10 shows an example of a screen page that can be displayed on the terminal prior to registering the playback appliance.

The server 3 may enable the user to register a plurality of playback appliances 2 within a single account, e.g. a plurality of digital picture frames, and the user can be allowed to give a name to each playback appliance, as shown in FIG. 11.

During a step 140, a user profile associated with the user account is defined via the terminal 4.

By way of example, the step 140 includes selecting the type of content to be played back and the content source from which the server is to search for content for playing back.

When the content is of the image type, the definition of the user profile may, for example, include the definition of an order in which images are to be played back, the definition of the frequency at which played-back images are to be changed, and the way in which a transition is to be made from one image to the next, e.g. by fading.

During step 140, the user may also determine whether the profile being created is to be public or private, and whether another user needs to pay or to satisfy certain conditions in order to gain access thereto. The term “user” should not be understood restrictively.

FIG. 13 shows an example of a screen page that can be displayed on the terminal 4 when the user accessing an account is viewing existing profiles.

By way of example, the server 3 may display an image of content for each profile, e.g. the first image of its content or an image selected randomly from the content as a whole.

Where appropriate, the server may also specify, for each profile, the number of images or of videos and may include an action button enabling the user to share a profile amongst a plurality of playback appliances.

While creating a profile, the terminal may receive a screen page of the kind shown in FIG. 12, for example.

By way of example, the user may check or uncheck boxes 90 to specify which playback appliances associated with the account are to be able to benefit from the newly-created profile.

The user may also select a stream to be added, e.g. a really simple syndication (RSS) stream, or a stream obtained via listed predefined third parties, e.g. in a list entitled “My friends” in the example of this figure.

The server 3 may also present an action button 91 on the screen page to enable the user to authorize public access to the profile being created.

The server 3 may also enable the user to access the profiles of third parties listed in the “My friends” list, as shown in FIG. 14.

The server 3 may be arranged to sort profiles for which access is public so as to present them to visitors to the server, e.g. by theme, as shown in FIG. 9, where one theme is about diving and another is about nature. Each public profile presented to visitors may be associated with at least one action button 93 enabling the corresponding profile to be added to the visitor's account, and an action button 94 enabling the content associated with the profile to be viewed before optionally adding that profile to the account.

A user profile may be complex to a greater or lesser extent and does not necessarily make use of a search engine on each content supplier site. In the limit, a user profile could be limited to a list of predefined links that are not changed by the server.

The user may also define the created profile as the default profile, i.e. the profile that will be selected automatically when the playback appliance 2 is put into operation.

During step 140, the user can also enter the identifier and/or the password of that user on the selected content supplier site.

The server 3 then sends an acknowledgment message during a step 150.

The steps 140 and 150 can be repeated as many times as desired by the user in order to create new user profiles.

The first connection to the server 3 relating to a given playback appliance 2 may take place on purchase of the playback appliance 2, for example, with some of the information being input by the vendor or by a dedicated assistance service contacted by the vendor, for example.

The first connection to the server 3 may also take place after purchase, e.g. immediately before installing the playback appliance 2 in its utilization surroundings, e.g. at home or in the office.

One or more connections to the server 3 may be made subsequently, e.g. for the purpose of adding a profile, modifying a profile, deleting a profile, or adding or deleting a playback appliance. Modifying a profile may comprise modifying access thereto.

The definition of the user profile may also include the user specifying for that profile whether or not the user desires to receive notification of new content relating to the profile being made available, e.g. each time the site that supplies the corresponding content is updated.

Deciding not to receive notification may be useful in particular when updates are very frequent, e.g. because the theme selected by the user gives rise to a large amount of updating, or because the user desires not to be interrupted while reading a current profile.

While creating a user account and/or for the purpose of modifying one or more user profiles, data can be input solely via the terminal 4 and not via the user interface 25 of the playback appliance 2.

The server 3 is arranged in such a manner as to enable the playback appliance 2 to receive content for playing back from the content supplier site(s) 5 defined by the user profile(s).

For example, the server 3 may be arranged in such a manner that the content for playing back is sent to the playback appliance 2 in push mode.

FIGS. 3 and 5 show an example of information being exchanged between the playback appliance 2, the server 3, and a content supplier site 5, with this example being applicable to circumstances in which the playback appliance 2 is a digital picture frame, amongst other possibilities.

During a first connection, i.e. when the playback appliance 2 is switched on, it begins by making connection to the network, e.g. the Internet, using the process corresponding to step 305, shown diagrammatically in FIG. 4.

In step 210, the processor unit 28 determines whether the playback appliance 2 is configured for making a connection to the network.

If it is, during a step 220, the processor unit 28 tests the capacity of the playback appliance to make a connection to the network.

For example, with a wireless connection, e.g. of the WiFi type, when one of the conditions specified in steps 210 and 220 is not satisfied, the processor unit 28 can act during a step 230 to test whether various WiFi networks are available.

Open WiFi networks are listed in a step 240. The term “open WiFi networks” is used to mean networks that are not encrypted, that do not require any identification, that do not make use of a proxy for connecting to the Internet, and that allocate Internet protocol (IP) addresses dynamically.

In a step 250, the processor 28 determines whether there remain any WiFi networks to be tested in the list.

When there are none, manual network configuration is performed in a step 260. To do this, the user makes use, for example, of the “menu” key on the user interface 25 and then inputs a WEP key or a WPA key, for example.

Connectivity to the network 6 is tested again in a step 270.

If this step 270 gives a negative result, then the processor unit 28 performs step 260 again.

If step 250 gives a positive response, then the processor unit 28 attempts to set up a connection to the network 6 during a step 280, which step is followed by a step 290 of verifying connectivity to the network 6.

If the response is negative, the processor unit 28 performs the step 280 again and reiterates the attempt at making a connection to the network. At the end of steps 220, 270, and 290, once the processor unit 28 determines that the playback appliance 2 can be connected to the network 6, it establishes a connection to the network 6 during a step 300.

Returning to FIG. 3, during a step 310 following the connection process 305, the playback appliance 2 sends identification information to the server 3. By way of example, this information comprises the MAC address of the playback appliance 2.

During a step 315, the server 3 sets up a connection with a content supplier site 5 as a function of the current user profile, e.g. the profile that was defined by the user as being the default profile, and the server 3 then requests from the supplier site 5 the list of content addresses that correspond to the profile.

By way of example, the content addresses are obtained via a suitable programming interface.

During a step 320, the server 3 can send to the playback appliance 2 the list of user profiles that are defined in the user account.

The purpose of sending this list may be to enable the user to modify the current profile.

During a step 325, the server 3 sends the reader software corresponding to the type of content for the current profile to the playback appliance 2.

During a step 330, the content supplier site 5 responds to the request received in step 315 by sending to the server 3 a list of links pointing to the looked-for contents. In the example described, these links are universal resource locator (URL) addresses.

Step 330 is followed by a step 335 during which the data received by the server during step 330 is sent by the server 3 to the playback appliance 2.

The playback appliance 2 may work in push mode, i.e. it is arranged during a step 340 to connect directly to the content supplier site 5.

During this step 340, the playback appliance 2 sends to the content supplier site 5 a request for the first content in the list it receives during the step 335, by supplying the corresponding address(es).

The content supplier site 5 responds to this request by sending the looked-for content in a step 345.

The playback appliance 2 plays back each content with the preferences that are defined in the current user profile as sent thereto while sending the reader in step 325.

The playback appliance 2 that has received the profile list can display the profiles and can enable the user to change the current profile by acting on the user interface 25, e.g. in order to choose to display images corresponding to some other theme.

For example, in order to modify the profile, the user makes use of the “change profile” key on the user interface 25.

FIG. 5 shows the various steps that can take place during a request to change profile.

It is assumed that the user has acted on the user interface 25 in order to request a new profile.

The playback appliance 2 then acts during a step 350 to request the server 3 to change profile. During a step 355, this request causes the server 3 to request from the content supplier site 5 in question the list of content for the newly-selected profile.

During a step 360, similar to above-described step 320, the server 3 sends, where appropriate, to the playback appliance 2 the read software that corresponds to the type of content defined in the newly-selected user profile.

Steps 365, 370, 375, and 380 correspond respectively to steps 330, 335, 340, and 345, but with the user profile as modified during step 350.

There follows a description with reference to FIG. 6 of an example of the server 3 searching for a change in the content available from the supplier site(s) corresponding to a user profile.

The server may be arranged in a step 400 to select a profile for testing from amongst all of the user profiles.

In a step 401, the server determines whether the user did or did not want to receive notification of new content updating. If not, the server ends the test procedure at step 402 relating to this profile. Otherwise, the user makes a connection in a step 403 to the content supplier site defined by the profile and, in a step 404, verifies whether there is any new content. This verification may be performed, for example, by downloading the content or stream list, by determining a hash value (or “hash” for short) for said content or stream list, and by comparing it with a preceding hash. The term “hash” is used to designate an alphanumeric string of defined length that is obtained by applying an algorithm to a file, in particular a text file, e.g. one of the algorithms known as SHA, or MD5. Two identical hash values mean that there is a very high probability that the corresponding files are identical, and thereby simplify comparing two long files.

During a step 405, the server determines whether the new hash is different from the preceding hash, and if not, it terminates at above-mentioned step 402. If it is different, then the server stores this information in a step 406 so as to be able to notify the playback appliance 2 that new content exists.

The server 3 may be arranged to enable the playback appliance 2 to receive notification of the new content.

The playback appliance 2 may be arranged in a step 500, as shown in FIG. 7, to interrogate the server 3 periodically. In a step 501, the server looks for the result of the test process described above with reference to FIG. 6. If there is an affirmative result, then the server 3 notifies the playback appliance 2 in a step 502 that new content exists and it sends in association therewith the type of the content, the address(es) of the content, and also the address of a reader enabling the content to be read.

When the user acts in a step 503 on the user interface of the playback appliance in order to cause the new content to be downloaded, the playback appliance acts in a step 504 by sending a request to the reader software server. The reader is sent to the appliance in a step 505.

The playback appliance also acts in a step 506 to request the address(es) of the new content from the corresponding content supplier site, with the content being sent in a step 507 to the playback appliance.

The receipt of a notification of new content can be notified to the user in various ways, e.g. by a message 600 appearing on the screen, as shown in FIG. 26.

By way of example, when the user comes into the proximity of the touch-sensitive keys, or indeed exerts any other action on the playback appliance, information relating to the new content can be displayed on the screen, e.g. its origin, its type, and its subject matter, and possibly also its size, as shown in FIG. 27. Functions 602 and 603 may also be displayed, e.g. for the purposes of accepting reception of the new content or of causing it to be deleted.

Functions 604 or 605 may optionally be provided for the purpose of banning or of thanking the source from which the new content originates. When the source is banned, the identifier of the source can be listed by the server so that it no longer accepts content from that source and no longer searches that source for content. When the source is thanked, the server may, for example, list an identifier for that source in a corresponding list, while waiting for an action from the user, and/or for causing a thank-you message to be sent automatically to the source.

The user may act on the playback appliance in order to cause images to be printed or the content being played back to be listed in a particular list, e.g. a list corresponding to favorites, or on the contrary a list corresponding to a trash bin, which list may be managed by the server 3, or possibly by the content supplier site from which the content cones.

FIG. 8 shows an example of information being exchanged between the playback appliance, the server, and a printer site. When the user acts on the user interface, e.g. by pressing on the print key while an image is being displayed, the playback appliance acts in a step 700 to send the address of the displayed content to the server 3. In a step 702, the server sends the address of the content for printing to a printer site that is predefined in the corresponding profile or more generally in the user account, where appropriate.

The user may then connect to that printer site in order to consult the set of images waiting to be printed and to provide payment means, where appropriate.

In a variant, the server 3 may send a list of sites to the playback appliance 2, from which list the user can select a particular site for performing the printing.

The playback appliance 2 may be embodied in various ways, in particular when it is in the form of a digital picture frame.

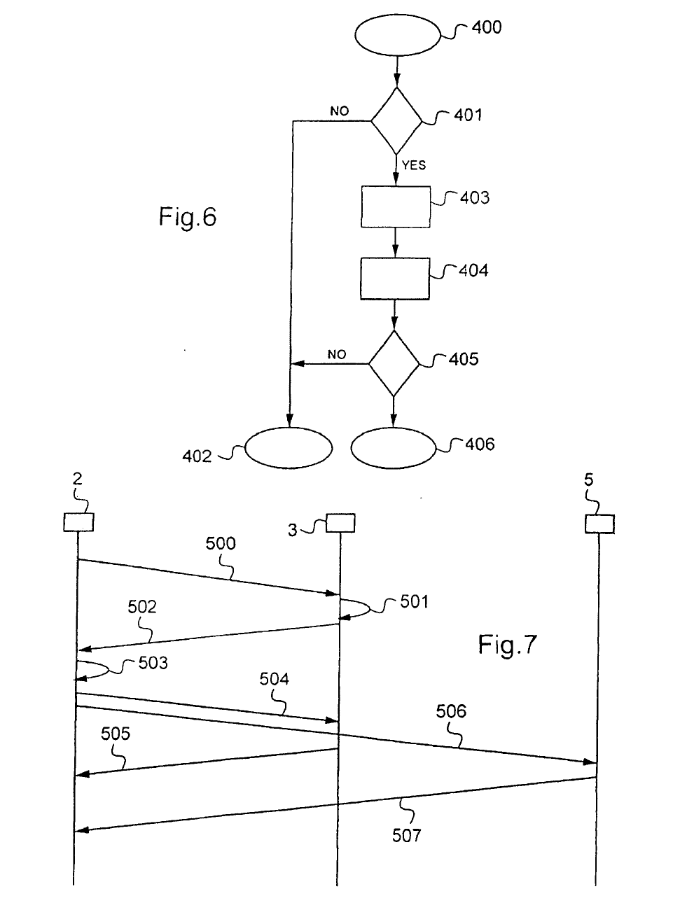

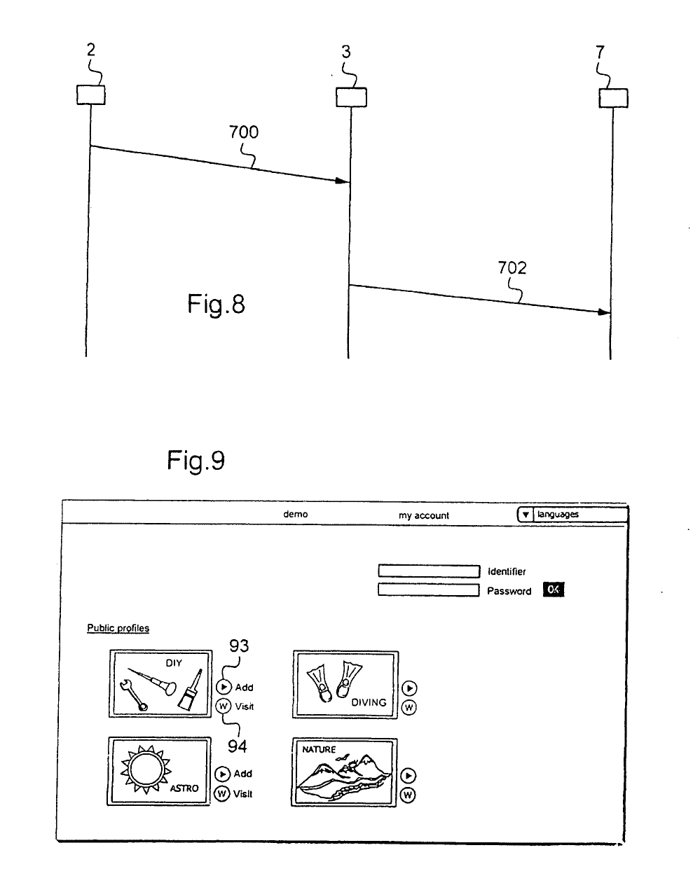

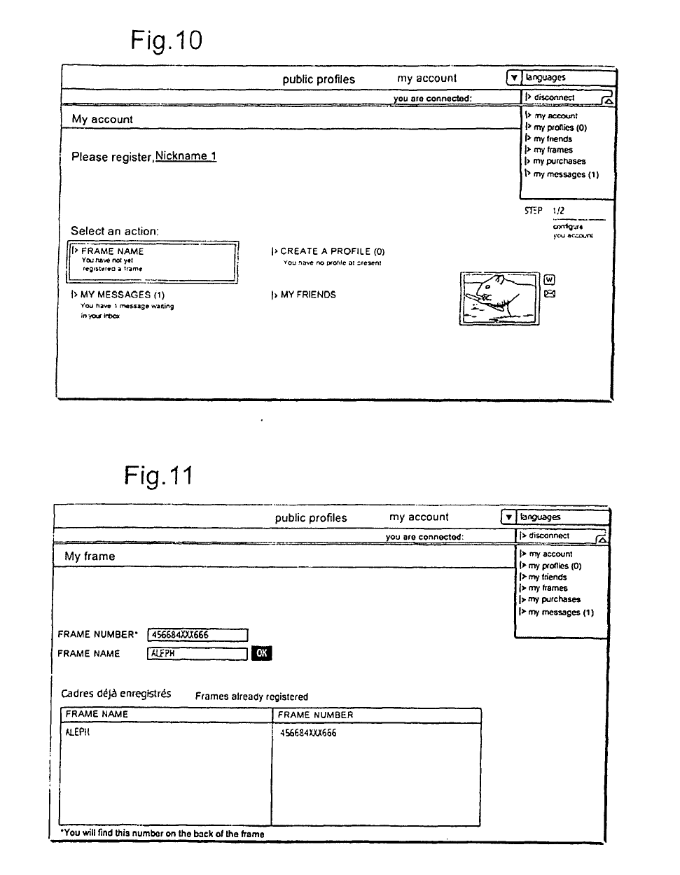

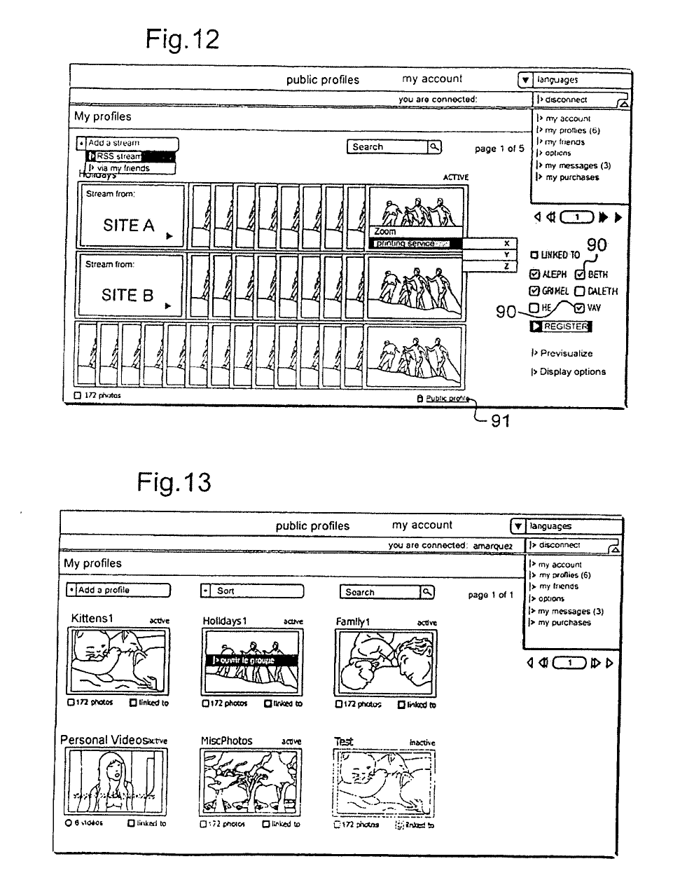

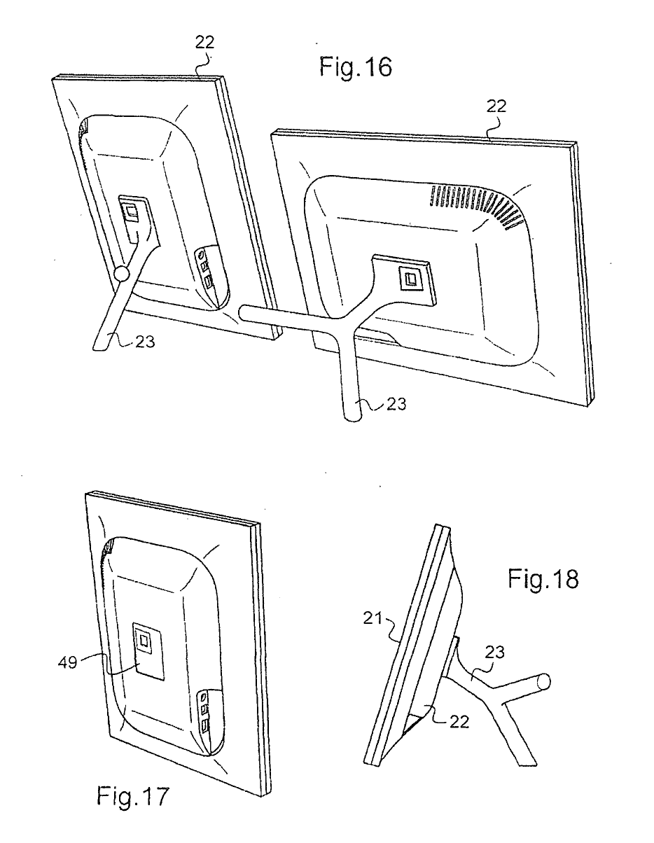

FIGS. 15 to 21 show a playback appliance in the form of a digital picture frame. Naturally, this is merely an example, and the invention also applies to other playback appliances 2, e.g. for playing back content that is exclusively audio, or to playback appliances that make use of a monitor or of a stereo system as playback means, for example.

In the example shown in FIGS. 15 to 21, the playback appliance 2 comprises an active internal module 36, a front facade 21, and a rear facade 22.

The active internal module 36 comprises, for example: a screen 20 and electronic cards 37, e.g. connected to the screen 20 by flexible cables and/or by electrical connectors.

The screen 20 may be of the back-lit LCD type.

The front facade 21 may comprise a tinted or semi-reflecting film or glass, e.g. made of bulk-tinted Plexiglass®, making the screen 20 invisible while it is switched off.

By way of example, the electronic card(s) 37 may be screwed or snap-fastened to the rear facade 22, possibly together with the screen 20. The front facade 21 can be fastened in various ways to the screen 20 and/or to the rear facade 22, e.g. by snap-fastening, screw-fastening, or by magnetic fastener means.

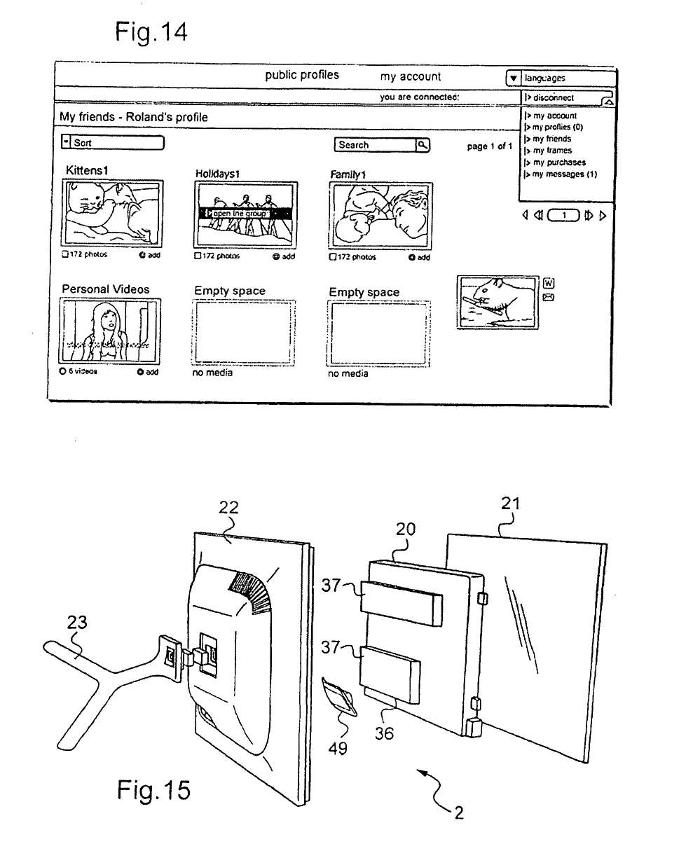

In its four corners, the rear facade 22 may include magnets (not visible in FIG. 15) in order to enable one or more trim elements to be releasably fastened on the rear facade 22, such as the trim elements 39 shown in FIGS. 19 and 20 by way of example.

As shown in FIG. 15, the playback appliance 2 may include a removable prop 23 that may be fastened magnetically to the rear facade 22.

In a variant, when there is no prop 23, as shown in FIG. 3, the playback appliance 2 can be held against a wall by means of a suitable picture hanger system, or in a variant it may be held in a desired position by one or more trim elements as shown in FIG. 19. In this figure, it can be seen that at least one trim element may include an extension 42 that enables the appliance to be stood up with a desired angle of inclination.

At least one trim element may be made of metal or may include magnetic portions, e.g. by including a filler of particles having non-zero magnetic susceptibility.

In the example of FIG. 19, the trim element 29 may thus have magnetic corner portions 43, e.g. made of metal, that are magnetized by magnets situated under the rear facade 22.

A cover 49 may be fastened to the rear facade to cover the location for receiving the prop 23, where appropriate.

In the example shown, the user interface comprises touch-sensitive keys 38 placed behind the front facade 21, e.g. six such keys.

By acting on one of the keys 38, the user can modify a content playback parameter, as explained above.

The invention is not limited to the implementations and embodiments described above.

The characteristics of the various implementations and embodiments may be combined in variants that are not shown.

In particular, it is possible to change the order of the steps in FIGS. 2 to 8 and to add additional steps or to replace certain steps by others, depending on the looked-for functions.

The expression “comprising a” should be understood as being synonymous with “comprising at least one” unless specified to the contrary.

What is claimed is:

1. A method of playing back at least one digital content by means of at least one appliance for playing back said content, the method comprising the following steps:
enabling at least one user account to be created on a server of a computer network providing access to at least one content supplier site, the account being created in particular by means of a terminal other than the playback appliance;
enabling at least one user profile to be defined on the user account; and
depending on the user profile, sending at least one address of digital content present on a content supplier site from the server to the playback appliance connected to the network, thereby enabling the playback appliance to recover and play back said digital content via playback means.

2. A method according to claim 1, including supplying the playback appliance together with the address of a server on the network and an identifier of the playback appliance.

3. A method according to claim 1, wherein the server sends to the playback appliance the list of user profiles existing on the account, and wherein the user is enabled to act on the playback appliance in order to select a user profile from the profiles in the list, so as to play back content corresponding to the selected profile.

4. A method according to claim 1, wherein the server sends to the playback appliance reader software for reading the digital content as a function of the type of the digital content that is to be played back.

5. A method according to claim 1, wherein the server is arranged, as a function of a user profile, to make at least one request with a content supplier site in order to obtain at least one address enabling the playback appliance to access at least one content corresponding to said user profile.

6. A method according to claim 1, wherein the creation of the user account includes supplying the server with an identifier of the playback appliance and an identifier of the user.

7. A method according to claim 1, including, during playback of content, a step consisting in enabling the user to act on a user interface of the playback appliance, and also including a step consisting in modifying, as a function of said action, the content that is received.

8. A method according to claim 1, including the step consisting in sending a notification to the playback appliance connected to the network, informing it that at least one new digital content for playback has been made available.

9. A method according to claim 8, wherein reception of the notification is signaled on the playback appliance by a sound and/or visual message.

10. A method according to claim 1, wherein the server sends to the playback appliance a list of addresses to which the playback appliance connects in succession in order to download corresponding contents.

11. A method according to claim 1, the playback appliance including a screen and being devoid of a complete alphanumeric keyboard, a hard disk, a floppy disk reader, or an optical disk reader.

12. A method according to claim 1, the playback appliance including wireless communication means for exchanging data with the computer network.

13. A method according to claim 12, the wireless communication means being WiFi means.

14. A method according to claim 1, the network being the Internet.

15. A method according to claim 1, including displaying on a screen of the playback appliance at least one function associated with a key of the playback appliance.

16. A method according to claim 15, the displayed function being a function of the played-back content.

17. A method according to claim 16, the displayed function being a function of the type of content and/or of the site from which it comes.

18. A method according to claim 15, including detecting that the user is in its proximity in order to cause the function to be displayed on the screen.

19. A method according to claim 1, wherein the terminal is capable of accessing content present on the supplier site and downloaded by the playback appliance.

20. A method according to claim 1, the playback appliance being a digital picture frame.

21. A computer system comprising:
an appliance for playing back digital content, the appliance not being provided with a complete alphanumeric keyboard, and being capable of accessing a network; and
a server accessible via the network, the server being arranged:
to enable a terminal to be connected to the server, in particular a terminal that is distinct from the playback appliance;
to enable a user account defining at least one user profile associated with the playback appliance to be created;
to search, as a function of the user profile, for at least one address on a content supplier site accessible via the network; and
to cause the playback appliance to download content from the content supplier site from the address as searched-for in this way.

22. A system according to claim 21, the playback appliance including sound and/or visual playback means.

23. A system according to claim 21, the server being arranged to cause the playback appliance to download content from the content supplier site at the looked-for address by sending the looked-for address to the playback appliance.

24. A digital content playback appliance comprising:
sound and/or visual playback means; and
a digital processor unit arranged to enable the appliance:
to connect automatically to a computer network server other than a messaging server;
to identify itself with the server;
to recover automatically from the server at least one address pointing to at least one content supplier site distinct from the server, said address(es) being a function of a user profile defined by the server; and
to connect automatically to the addresses received from the server to recover the content for playback.

25. An appliance according to claim 24, including at least one trim element fitted with releasable fastener means.

26. An appliance according to claim 25, the releasable fastening being magnetic fastening.

27. An appliance according to claim 24, the means including a screen, the appliance including a tinted or semi-reflecting glass or film covering the screen, at least in part.

28. An appliance according to claim 24, including a user interface having means for displaying on a screen at least one function associated with a key of the appliance.

29. An appliance according to claim 28, the function being displayed in response to an action of the user or to detecting that the user is in the proximity of the appliance.

30. An appliance according to claim 28, the displayed function depending on the played-back content.

31. A server enabling a playback appliance according to claim 24 to be connected via a network, the server being arranged to enable a user account to be created and at least one user profile to be defined, and as a function of said profile, to search at least one digital content supplier site for at least one address of content corresponding to the profile, and to send said address to the playback appliance in order to enable it to download the content corresponding to the address.

32. A server according to claim 31, arranged to send to the playback appliance the list of user profiles associated with a user account and to receive information from the playback appliance relating to the profile that has been selected.

33. A method of playing back digital content by means of a content playback appliance, the method comprising the following steps:
enabling at least one user profile associated with a user account to be defined on a server of a computer network giving access to at least one content supplier site;
as a function of the user profile, sending from the server to the playback appliance connected to the network, at least one address of digital content present on a content supplier site in order to enable the playback appliance to recover the digital content and play it back via sound and/or visual playback means;
enabling the server to send to the playback appliance a list of user profiles associated with a user account;
enabling the user to select a user profile by acting on a user network of the playback appliance; and
as a function of the new user profile as selected in this way, sending to the playback appliance at least one address of corresponding digital content.

34. A method according to claim 33, the playback appliance being a digital picture frame.

35. A method according to claim 33, including the step consisting in sending to the playback appliance the reader software that corresponds to the content for which the address has been sent.

36. A method of playing back digital content by means of a content playback appliance, the method comprising the following steps:
periodically using the playback appliance to interrogate a server arranged to notify the availability of new digital content;
using the server to interrogate at least one supplier site in order to detect the presence on said supplier site of new digital content, and in the affirmative, to notify the presence of said new digital content to the playback appliance;
using the server to send a notification to the playback appliance relating to the presence of new digital content, said notification comprising at least the address enabling the new content to be recovered from the supplier site; and
in response to an action of the user on a user interface, enabling the playback appliance to recover the digital content at the address as communicated in this way by the server.

37. A method according to claim 36, the playback appliance being a digital picture frame.

38. A method according to claim 36, the notification including the address of reader software corresponding to the new content.
